(19) United States
(12) Patent Application Publication
(10) Pub. No.: US 2020/0026096 A1
(43) Pub. Date: Jan. 23, 2020

(54) FRAME FOR SPECTACLES, A MONOCLE OR A LORGNON

(71) Applicant: Jüergen Graf, Weyher (DE)

(72) Inventor: Jüergen Graf, Weyher (DE)

(21) Appl. No.: 16/082,077

(22) PCT Filed: Mar. 4, 2017
(86) PCT No.: PCT/DE2017/100174

§ 371 Date: Sep. 4, 2018

(30) Foreign Application Priority Data
Mar. 4, 2016 (DE) 10 2016 104 011.8

(51) Int. Cl. G02C 5/00

(52) U.S. Cl. CPC G02C 5/008

(57) ABSTRACT

Frame for a pair of glasses (spectacles), a monocle or a lorgnon with a base frame body for receiving optical elements wherein the base frame body is made from wood which has been subjected to an extraction with a medium containing alcohol

The present invention relates to a frame for a pair of glasses (also known as spectacles), a monocle or a lorgnon.

Frames for spectacles, monocles or lorgnons are known per se. These include, depending on whether they are intended for a pair of glasses (spectacles), a monocle or a lorgnon, one or more frame elements for receiving the glasses (hereinafter referred to as base frame body) and one or more frame temples or frame handles.

DE 20 2009 015 326 discloses a spectacle frame made of natural horn.

From DE 6943178 wooden spectacles with a swivel and removable glasses are known. Further details on the type of wood used can not be found in this document.

From DE 20301522 natural spectacles are known in which the temple, the nose part, the half-round part or the full-rim part of the glasses consists of 100% of a material selected from deer horn, wood, ivory or other natural materials.

From DE 34 36 959 a laminate for a spectacle frame is known, which may contain a layer of wood between two layers of horn. Information of any kind on the type of wood used can not be found in this document.

From DE 20 2014 001 236 a spectacle frame for holding eyeglass lenses with a front and two temples is known, each temple having at least at one end a laminate with at least one layer of wood and at least one horny layer, wherein the wood layer from the first end via a section extends along the temple and the horny layer extends over the entire length of the temple.

From DE 20 2015 103 674 a frame for a pair of glasses or a monocle or a lorgnon is known, which includes at least one frame member which is constructed of a mineral composite material at least in sections thereof.

The subject of DE 8429806 is a spectacle frame, consisting of a central part for receiving glasses (lens frame) and two brackets hinged on the central part, wherein for at least one frame part natural horn is used.

From WO 2008/078823 glass frames for spectacles are known, which contain a component which is formed from a wood which has been subjected to a treatment at elevated pressure and elevated temperature.

Finally, JP 2009/217255 describes spectacle frames essentially made of wood, but no indication of a treatment of the wood used is given. Glasses whose frames are made of wood are called wooden glasses.

Although wood is a cheap and common commodity, the material is uncommon and rare in eyewear.

Wooden glasses described in the literature and commercially available are made of natural wood after appropriate processing. However, such spectacles have certain drawbacks resulting from the fact that wood “works” as a natural material and contains ingredients that have adverse effects on long-term dimensional stability.

There is therefore still a need for spectacles, monocles and lorgnons with frames, in particular base frame bodies, based on wood which serve to accommodate the glasses and, which have a sufficient dimensional stability over extended periods of time.

It was therefore an object of the present invention to provide frames for glasses, monocles or lorgnons on the basis of wood, which do not have the disadvantages described above.

This object is achieved by frames for spectacles, monocles or lorgnons according to claim 1.

Preferred embodiments of the invention are set forth in the dependent claims and the detailed description hereinafter.

The frame according to the invention for a pair of spectacles, a monocle or a lorgnon has a frame base body which is made of wood which has been subjected to extraction with an alcohol-containing medium.

In addition to the frame base body, other elements of the inventive frames for a pair of glasses, a monocle or a lorgnon may also be made of appropriate wood. By way of example, only the temples (frame bracket) or the handles (frame handles) of a monocle or lorgnon may be mentioned, which can be made from appropriate wood.

As the alcohol-containing medium any liquid or gaseous medium is suitable which contains or consists of an alcohol, preferably an alcohol having 1 to 4 carbon atoms and particularly preferably ethanol. The content of alcohol is not particularly limited and may be in the range of 2 to 100, preferably 5 to 50, and more preferably 7 to 50% by weight.

The temperature of the extraction is not subject to any particular restrictions either and may vary depending on the extraction medium used and its content of alcohol. In some cases, extraction temperatures ranging from 0° C. to the boiling point of the alcohol used have been found to be advantageous. If necessary, the temperature can be lowered by extraction at increased pressure

Finally, the duration of the extraction with the medium comprising an alcohol is not subject to any particular limitation. The period of time over which the extraction is carried out can range from a few hours to several months or years (in particular, if, according to a preferred embodiment of the invention, wood is used in which alcoholic beverages, in particular wine or spirits such as e.g. whiskey or gin or fortified drinks such as port wine have been stored). In some cases, extraction times ranging from one day to two years, preferably from one week to one year, have been found to be advantageous. By increasing the temperature or pressure or through a combination of both these measures, the extraction time can be shortened or adjusted if deemed necessary.

Principally, any type of wood is suitable for extraction by bringing same into contact with an alcohol-containing medium. Accordingly, wood from tree or coniferous trees, wood from local production or tropical wood may be used depending on the individual application case.

Preferably wood obtained from used barrique barrels, particularly preferably from oak wood obtained from used barrique barrels is used.

Particularly preferred wood from barrique barrels is used in which wine or other alcoholic beverages, especially spirits such as gin or whiskey or fortified drinks such as port wine, to name only three examples, have been stored.

When using wood obtained from containers in which alcoholic beverages have been stored (e.g. barrique barrels) no separate extraction with a medium containing alcohol is necessary, i.e. such wood can be used immediately and without further pretreatment.

Wood which has been subjected to extraction with alcohol containing media, e.g. wood obtained from containers in which alcoholic beverages have been stored, has a better dimensional stability and moisture resistance over extended periods of time compared to natural wood which has not been in contact with alcoholic beverages. This is important for use in eyeglass frames because a good dimensional stability is crucial for a firm and stable fit of the glasses in a wood frame.

Through the contact with alcoholic beverages certain ingredients are leached (extracted) out of the wood (especially tannins and similar components), which in natural wood react to changes in temperature and humidity and thereby cause problems.

Natural wood without treatment “works” in different temperatures and humidity in itself, which means that wooden glasses made of a simple piece of wood quickly becomes cracks and is damaged. Therefore, wooden glasses made of natural wood are usually made of glued plywood (veneer wood). Veneer wood, i.e. several layers of wood which have been glued together in different directions of the grain, when compared with natural wood has a better stability. However, this method of preparation is expensive and increases the cost of wooden glasses considerably.

In the frames in accordance with the present invention, in an ideal case the use of several veneer layers may be dispensed with entirely or the number of veneer layers needed can at least be reduced. By using wood which has been in contact with alcoholic media for certain periods of time (e.g. several days up to several months or several years) the frames in accordance with the present invention are less subject to changes as a result of different temperatures or different humidities.

However, it is also readily possible to obtain the frames in accordance with the present invention in a conventional manner by veneering several wood layers made of wood which was subjected to an extraction with an alcohol-containing medium or by combining a treated wood with other components if this is desired for technical or aesthetic reasons. Therefore, no special method for manufacture of the frames in accordance with the present invention is necessary; conventional processes may also be used.

The frames according to the invention comprise one or more frame members (elements). The concrete number and geometrical-structural design of the frame elements are essentially determined by the overall construction of the frame, i.e depending on whether it is a frame for a pair of glasses (spectacle or glasses frame) or a frame for a monocle or a frame for a lorgnon.

The frame according to the invention has a so-called frame base body which includes corresponding receptacles (seats) for optical elements such as glasses for spectacles, monocles or lorgnons. Frame base bodies for a spectacle frame typically have receptacles for two spectacle glasses (the same applies to frames for lorgnons) whereas frame bodies for monocles have one receptacle for a spectacle glass.

In addition to the frame base body, the frames according to the invention, in turn, depending on whether same are frames for a pair of glasses (spectacles), a monocle or a Lorgnon, one or more frame temple (earpiece) or a frame handle. A corresponding frame templet or frame handle may be integrally formed with the main body of the frame or be connected as a separate component directly or indirectly with the body (for example, through a hinge).

A temple (earpiece) attached to a base frame body in the case of spectacles is usually movable, in particular pivotable, relative to the base frame body. This mobility is achieved by hinges or similar elements. These are typically arranged or formed between the temple (earpiece) and the base frame body and connected to both the base frame body and the temple (earpiece).

Hinges which connect the base frame body with the temples (earpieces) in a spectacle frame are usually made from metallic materials or from plastics.

In accordance with an embodiment of the invention, it is also possible to use temples (earpieces) made from a combination of different materials. This enables a variety of design options which may have aesthetic as well as technical effects. Processes for the manufacture of such temples (earpieces) are known per se and have been described in the literature so that no further details need to be given here. Just by way of example, DE 20 2014 001 236 may be mentioned in which spectacle frames with temples (earpieces) made from at least two materials and processes for their manufacture are disclosed.

Methods for producing frames based on wood for spectacles, monocles or lorgnons are also known per se and have been described in the literature, so that reference is also made in this regard to the respective prior art.

The frames according to the invention have both technical and aesthetic advantages over the known prior art frames based on wood.

For one thing, in particular through the use of wood containers in which alcoholic beverages have been stored, a wood can be used which otherwise would only be supplied to thermal utilization, i.e. wood can be used, which would otherwise be burned. This leads to a conservation of natural resources, since no fresh natural wood needs to be used.

Furthermore, by virtue of the use of wood from appropriate containers also decorative and aesthetic effects can be achieved by using parts of these containers on which an imprint that gives information about the contents of the container is present. Thereby it is possible that the frame gives immediate information on the type of natural material it has been made from.

It is principally possible that e.g. friends of wine have manufactured for themselves a spectacle frame or a frame for a monocle or a lorgnon from wood of a container (barrel), in which their favorite wine has been stored and which thus directly provides information on its origin.

The present invention also relates to the use of wood, which has been subjected to an extraction with alcohol containing media for the manufacture of base frame bodies for frames for spectacles, monocles or lorgons.

A further subject of the present invention are spectacles, monocles or lorgnons with a frame in accordance with the present invention.

1. Frame for a pair of glasses (spectacles), a monocle or a lorgnon with a base frame body for receiving optical elements wherein the base frame body is made from wood which has been subjected to an extraction with a medium containing alcohol.

2. Frame in accordance with claim 1 with frame temples or frame handles made form wood which has been subjected to an extraction with a medium containing alcohol.

3. Frame in accordance with claim 1 or 2 wherein wood from containers in which alcoholic beverages have been stored, is used.

4. Frame in accordance with claim 3 wherein wood from used barrique barrels is used.

5. Use of wood which has been subjected to an extraction with alcohol-containing media for the manufacture of base frame bodies for frames in accordance with any of claims 1 to 4 for spectacles, a monocle or a lorgnon.

6. Pair of glasses for spectacles, a monocle or a lorgnon with a frame in accordance with any of claims 1 to 4.
